(19) United States
(12) Patent Application Publication
(10) Pub. No.: US 2016/0375878 A1
(43) Pub. Date: Dec. 29, 2016

(54) VEHICLE WASHING APPARATUS

(71) Applicant: JAMES STECKLER, Langley (CA)

(72) Inventor: JAMES STECKLER, Langley (CA)

(21) Appl. No.: 14/748,620

(22) Filed: Jun. 24, 2015

(51) Int. Cl. B60S 3/04; B05B 7/04; B05B 1/08; B08B 3/02

(52) U.S. Cl. CPC B60S 3/04; B08B 3/02; B05B 7/0408; B05B 1/08

(57) ABSTRACT

A vehicle washing apparatus can include a fluid mixing circuit, a distribution conduit, and a first plurality of spray nozzles. The fluid mixing circuit can have a first inlet, a second inlet, and an outlet in fluid communication with both of the first inlet and the second inlet. The distribution conduit can extend in a u-shape with first and second vertical sections and a horizontal section extending transverse to and between the first and second vertical sections. The distribution conduit can have an interior passageway defining a flow path washing and detergent liquid and a third inlet in fluid communication with the outlet. The first plurality of spray nozzles can each be mounted on the distribution conduit and be in fluid communication with the interior passageway. Each of the first plurality of spray nozzles can be a fluidic oscillator.

### BACKGROUND

1. Field

The present disclosure relates to a vehicle wash apparatus and more particularly to a vehicle wash apparatus adapted to be used in a residential garage.

2. Description of Related Prior Art

U.S. Pat. No. 3,368,571 discloses an AUTOMATIC CAR WASHING APPARATUS AND CONTROL DEVICE THEREFOR. The device relates to an automatic car washing apparatus for installation about any suitable framework and through which an automobile may be driven and more particularly to a car wash apparatus that may be installed about the entrance of any private garage, and to a then-novel detergent mixing device for use therewith although not limited specifically thereto.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A vehicle washing apparatus can include a fluid mixing circuit, a distribution conduit, and a first plurality of spray nozzles. The fluid mixing circuit can have a first inlet configured to receive a washing liquid, a second inlet spaced from the first inlet and configured to receive a detergent liquid, and an outlet for emitting mixed washing liquid and detergent liquid. The outlet can be in fluid communication with both of the first inlet and the second inlet. The distribution conduit can extend in a u-shape with a first vertical section, a second vertical section, and a horizontal section extending transverse to and between the first vertical section and the second vertical section. The distribution conduit can have an interior passageway defining a flow path for the mixed washing liquid and detergent liquid and a third inlet in fluid communication with the outlet to receive the mixed washing liquid and detergent liquid. The first plurality of spray nozzles can each be mounted on the distribution conduit and be in fluid communication with the interior passageway. Each of the first plurality of spray nozzles can be a fluidic oscillator.

### BRIEF DESCRIPTION OF THE DRAWINGS

The detailed description set forth below references the following drawings:

FIG. 1 is a perspective view of a vehicle washing apparatus according to an exemplary embodiment of the present disclosure;

FIG. 2 is a perspective view of a spray nozzle of a vehicle washing apparatus according to an exemplary embodiment of the present disclosure;

FIG. 3 is a cross-section of a spray nozzle of a vehicle washing apparatus according to an exemplary embodiment of the present disclosure; and

FIG. 4 is a schematic view of a fluid mixing circuit of a vehicle washing apparatus according to an exemplary embodiment of the present disclosure.

### DETAILED DESCRIPTION

The present disclosure, as demonstrated by the exemplary embodiment described below, can provide a vehicle washing apparatus adapted for use in a residential garage. The apparatus can include fluidic oscillators to increase the surface area of the vehicle that is subjected to relatively high-pressure fluid spray. Fluid oscillators need not be externally powered, being driven in oscillating movement by the passage of fluid through them. Fluid oscillators can generate an oscillating jet of fluid at high frequency.

In residential washing systems, the position of each spray nozzles is static. The dispersion pattern of the washing and detergent fluid had to be relatively large to ensure the application of the washing and detergent fluid on the entire surface of the vehicle to be washed. However, as the dispersion pattern is increased, the strength or intensity of the spray diminishes. The present disclosure overcomes this un-appreciated deficiency in the art. In the present disclosure, the fluid discharge can be concentrated and thus relatively strong, while the dispersion pattern can be enhanced.

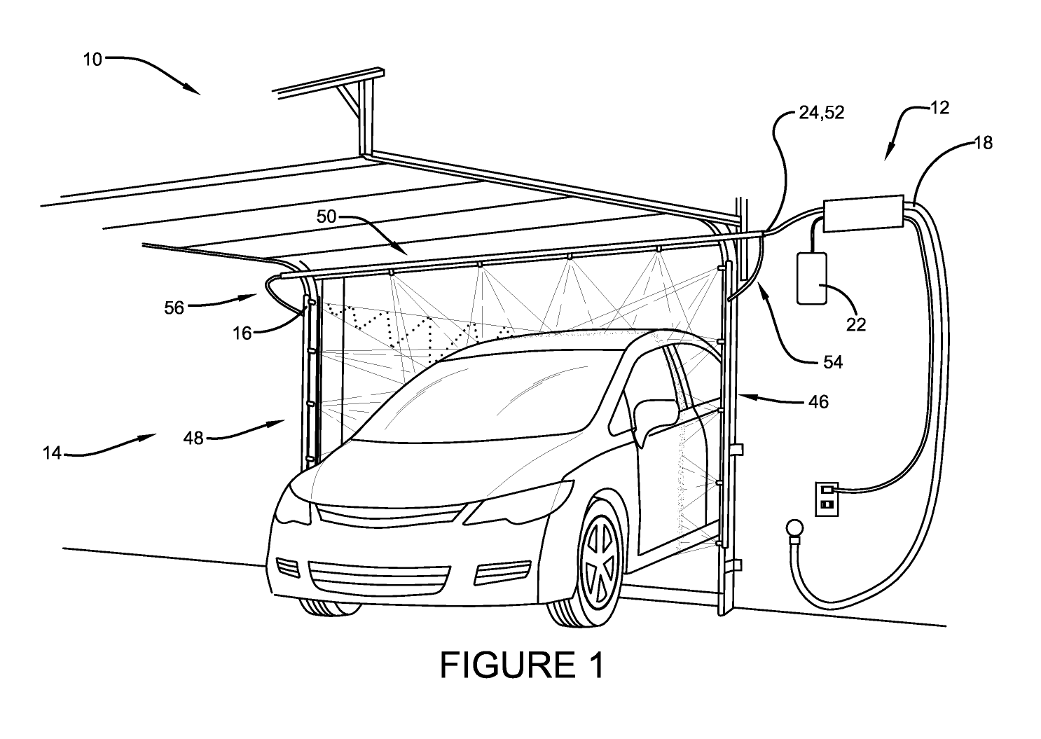

Referring now to FIG. 1, a vehicle washing apparatus 10 can include a fluid mixing circuit 12, a distribution conduit 14, and a first plurality of spray nozzles 16. The apparatus 10 can provide a residential washing system for vehicles. The apparatus 10 can discharge fluid in concentrated and thus relatively strong bursts while concurrently providing a dispersion pattern that can be enhanced in size.

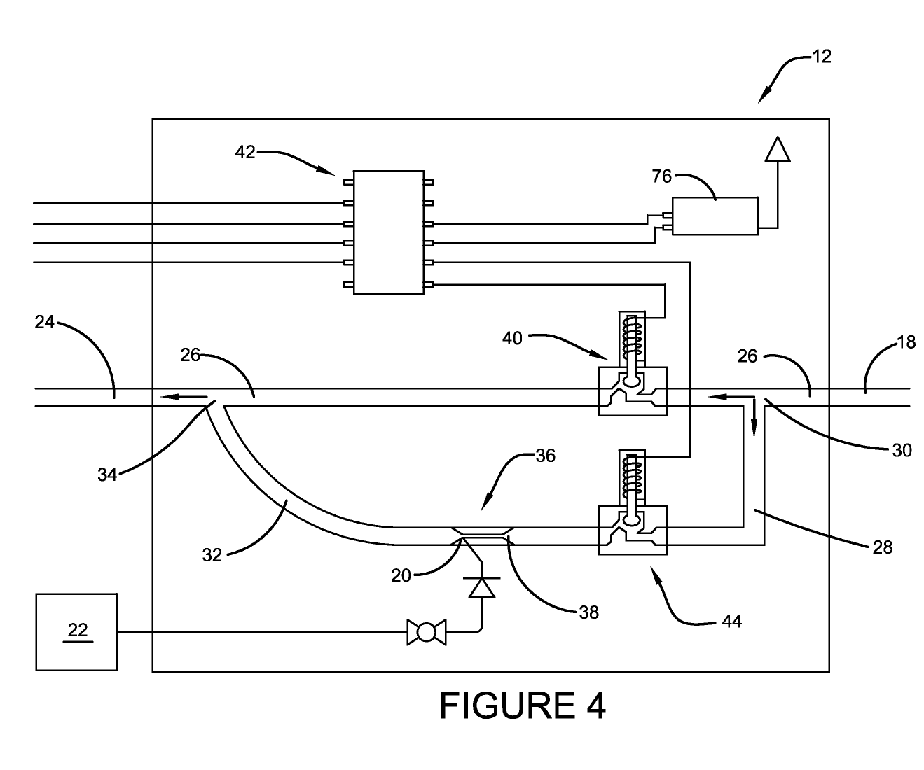

Referring now to FIG. 4, the fluid mixing circuit 12 can have a first inlet 18 configured to receive a washing liquid. The washing fluid can be water. The fluid mixing circuit 12 can also have a second inlet 20 spaced from the first inlet 18 and be configured to receive a detergent liquid. The detergent liquid can be soap and can be stored in a container 22. The first inlet 18 can be upstream of the second inlet 20. The fluid mixing circuit 12 can also have an outlet 24 for emitting mixed washing liquid and detergent liquid. The outlet 24 can be in fluid communication with both of the first inlet 18 and the second inlet 20.

The fluid mixing circuit 12 can also include a first conduit portion 26 extending between the first inlet 18 and the outlet 24. The fluid mixing circuit 12 can also include a second conduit portion 28 extending away from the first conduit portion 26 at a position 30 along the first conduit portion 26 spaced from the first inlet 18. The fluid mixing circuit 12 can also include a third conduit portion 32 extending away from the second inlet 20. The third conduit portion 32 can extend to the first conduit portion 26 at a position 34 along the first conduit portion 26 spaced from the outlet 24.

The fluid mixing circuit 12 can also include a venturi 36 positioned at the second inlet 20. An inlet 38 of the venturi 36 can be in fluid communication with the first inlet 18. The second conduit portion 28 can extend from the position 30 to the inlet 38 of the venturi 36.

A first electronic control valve 40 can be positioned along the first conduit portion 26. A controller 42 can be disposed in electronic communication with the first electronic control valve 40 and be configured to selectively open and close the first electronic control valve 40. A second electronic control valve 44 can be positioned along the second conduit portion 28. The controller 42 can be disposed in electronic communication with the second electronic control valve 44 and be configured to selectively open and close the second electronic control valve 44.

Referring again to FIG. 1, the distribution conduit 14 can extend in a u-shape with a first vertical section 46, a second vertical section 48, and a horizontal section 50. The first vertical section 46 and the second vertical section 48 can be elastic to allow the sections 46, 48 to spring right back when bumped and prevent damage. The horizontal section 50 can extend transverse to and between the first vertical section 46 and the second vertical section 48. The distribution conduit 14 can have an interior passageway defining a flow path for the mixed washing liquid and detergent liquid. The distribution conduit 14 can include a third inlet 52 in fluid communication with the outlet 24 to receive the mixed washing liquid and detergent liquid.

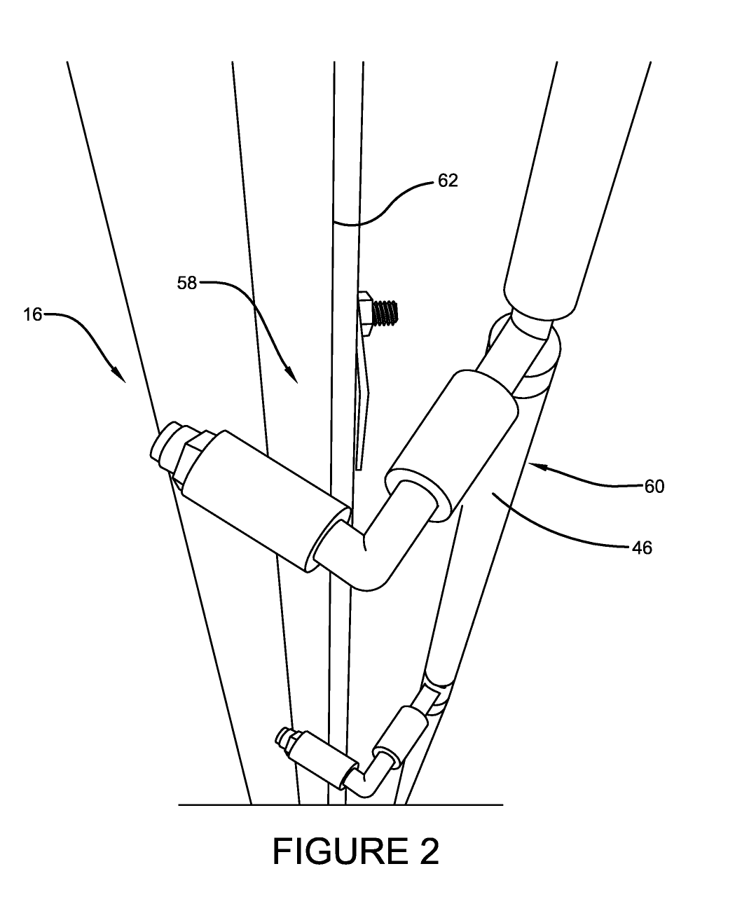

The first vertical section 46 and the second vertical section 48 can extend in a first plane. The first plane can be the plane of a residential garage opening. The horizontal section 50 can extend parallel to and be spaced from the first plane. The distribution conduit 14 can further include arcuate corner portions 54, 56 extending between the first and second vertical sections 46, 48 and the horizontal section 50. In the exemplary embodiment, the outlet 24 of the fluid mixing circuit 12 communicates with the interior passageway at the arcuate corner portion 54. The corner portions 54, 56 can be arcuate or extend in a second plane that is transverse to the first plane. As shown in FIG. 2, this structural arrangement allows, in the exemplary embodiment, for the first and second vertical sections 46, 48 to be recessed behind the tracks 62 of a garage door while the horizontal section 50 to be below the garage door when the garage door is open. The first and second vertical sections 46, 48 which might otherwise be in the way are recessed while the horizontal section 50 which would not interfere with garage opening are positioned closer to the vehicle.

The first plurality of spray nozzles 16 can each be mounted on the distribution conduit 14 and be in fluid communication with the interior passageway. Each of the first plurality of spray nozzles 16 can be a fluidic oscillator. Suitable fluidic oscillators can be acquired from Bowles Fluidics. U.S. Pat. Nos. 7,111,800; 7,267,290; and 7,478,764 are hereby incorporated by reference as fluidic oscillators that can be applied in one or more embodiments of the present disclosure. FIG. 1 shows the general effect of the fluid oscillators for the distribution pattern of the referenced spray nozzle 16. The other spray nozzles 16 positioned about the distribution conduit 14 can emit fluid in a similar pattern; this has not been shown only to more clearly show the pattern of one spray nozzle 16.

Referring now to FIG. 2, the apparatus 10 can include a first plurality of stems 58. The perspective of the view of FIG. 2 is looking downward along the vertical section 46. Each of the first plurality of stems 58 can be hollow and projecting away from the distribution conduit 14. One of the first plurality of spray nozzles 16 can be mounted on a distal end of one of the first plurality of stems 58. Each of a first plurality of check valves 60 can be disposed upstream of one of the first plurality of spray nozzles 16 and be positioned in one of the first plurality of stems 58, spaced from the distribution conduit 14. The stems 58 further allow for the first and second vertical sections 46, 48 to be recessed behind the tracks 62 of a garage door.

In or more embodiments of the present disclosure, the stems 58 can be adjustable such that a position of each of the first plurality of spray nozzles 16 is positionable in a plurality of different static positions. A static position is a position in which the nozzle 16 will remain after adjustment of the stem 58; the stem 58 will not elastically recover and move the nozzle 16 away from the static position. Each stem 58 can be connected to one of the vertical sections 46, 48 with a 3-way hose connector (or T fitting). Each stem 58 can be rotated about its central axis relative to the section of the distribution conduit 14 to which it is connected to define different static positions. The nozzles in the horizontal section 50 can also be positionable in a plurality of different static positions. As shown in FIG. 1, the various nozzles are arranged to direct water at the vehicle properly.

The first plurality of spray nozzles 16 can be positioned along the first vertical section 46, the second vertical section 48, and the horizontal section 50. Alternatively, the vehicle washing apparatus 10 can include a second plurality of spray nozzles 64 as shown in cross-section in FIG. 4. The second plurality of spray nozzles 64 can be mounted on the horizontal section 58 while the first plurality of spray nozzles 16 are positioned along the first vertical section 46 and the second vertical section 48. The second plurality of spray nozzles 64 can be structurally different from the first plurality of spray nozzles 16. In one or more embodiments of the present disclosure, each of the second plurality of spray nozzles 64 can include a self-sealing valve.

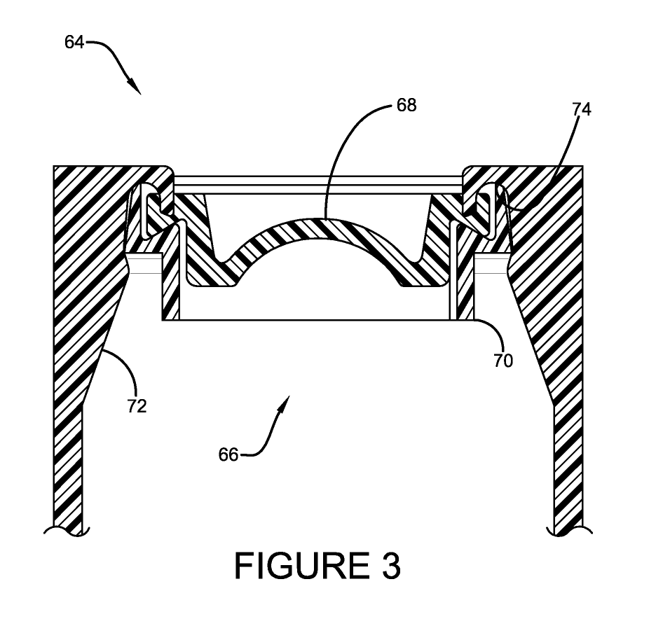

As shown in FIG. 3, a nozzle 64 can also include a self-sealing valve 66 to prevent drips. The self-sealing valve 66 can be positioned on an outlet side of the nozzle 64. The valve 66 can include a valve sealing member 68 and a valve frame member 70. An opening in the sealing member 68 can allow fluid to pass and be shaped as desired to produce a particular dispersion pattern. The valve sealing member 68 can be mounted on the valve frame member 70. Such a valve can be purchased from Liquid Molding Systems, located at 2202 Ridgewood Drive, Midland, Mich. 48642, USA, whose part number is SureSnap SA634. The nozzle 64 can include a tapered portion 72 for facilitating the insertion of the valve 66 and an annular groove 74 for receiving the valve 66. The nozzles 64 can be mounted on the horizontal section 50 since the top of the vehicle will not be as dirty or as visible as the sides of the vehicle.

In operation, a user can operate a switch such as switch 76 shown in FIG. 5. In one or more embodiments of the present disclosure, the apparatus 10 can be engaged wirelessly and/or automatically. Engaging the switch to an “on” position can cause the controller 42 to open the valve 40 and start the flow of washing fluid through the first conduit portion 26 and into the distribution conduit 14. After some predetermined period or time or at the same time the valve 40 is opened, the controller 42 can control the valve 44 to open and start the flow of washing fluid through the second and third conduit portions 28, 32 and through the venturi 36. The Venturi effect can draw detergent fluid through the second inlet 20, to fix with the washing fluid at the position 34. The inter-mixed washing fluid and detergent fluid can then pass through the outlet 24 and into the distribution conduit 14.

The inter-mixed washing fluid and detergent fluid can then pass through the spray nozzles 16 and, as applicable, spray nozzles 64. At the least the spray nozzles 16 having fluidic oscillators can disperse the inter-mixed washing fluid and detergent fluid with relatively strong intensity in a relatively broad dispersion pattern. The apparatus 10 can cease operations by engaging the switch 76, the controller 42 can cease operations after some predetermined period of time, or the apparatus 10 can include sensors to detect when a vehicle has passed through the garage opening.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A vehicle washing apparatus comprising:
a fluid mixing circuit having a first inlet configured to receive a washing liquid, a second inlet spaced from the first inlet and configured to receive a detergent liquid, and an outlet for emitting mixed washing liquid and detergent liquid, said outlet in fluid communication with both of said first inlet and said second inlet;
a distribution conduit extending in a u-shape with a first vertical section, a second vertical section, and a horizontal section extending transverse to and between said first vertical section and said second vertical section, said distribution conduit having an interior passageway defining a flow path for the mixed washing liquid and detergent liquid and a third inlet in fluid communication with said outlet to receive the mixed washing liquid and detergent liquid;
a first plurality of spray nozzles each mounted on said distribution conduit and in fluid communication with said interior passageway; and
wherein each of said first plurality of spray nozzles is a fluidic oscillator.

2. The vehicle washing apparatus of claim 1 further comprising:
a first plurality of stems, each of said first plurality of stems being hollow and projecting away from said distribution conduit, and wherein one of said first plurality of spray nozzles is mounted on a distal end of one of said first plurality of stems.

3. The vehicle washing apparatus of claim 2 wherein each of said first plurality of stems is further defined as deformable such that a position of each of said first plurality of spray nozzles is positionable in a plurality of different static positions.

4. The vehicle washing apparatus of claim 2 further comprising:
a first plurality of check valves, each of said first plurality of check valves disposed upstream of one of said first plurality of spray nozzles.

5. The vehicle washing apparatus of claim 4 wherein each of said first plurality of check valves is positioned in one of said first plurality of stems and spaced from said distribution conduit.

6. The vehicle washing apparatus of claim 1 further comprising:
a second plurality of spray nozzles each including a self-sealing valve.

7. The vehicle washing apparatus of claim 6 wherein said first plurality of spray nozzles are positioned along said first vertical section and said second vertical section.

8. The vehicle washing apparatus of claim 7 wherein said first plurality of spray nozzles are positioned along said horizontal section.

9. The vehicle washing apparatus of claim 1 wherein said first inlet is further defined as upstream of said second inlet.

10. The vehicle washing apparatus of claim 1 wherein said fluid mixing circuit further comprises:
a venturi positioned at said second inlet, wherein an inlet of said venturi is in fluid communication with said first inlet.

11. The vehicle washing apparatus of claim 10 wherein said fluid mixing circuit further comprises:
a first conduit portion extending between said first inlet and said outlet;
a second conduit portion extending away from said first conduit portion at a position along said first conduit portion spaced from said first inlet and extending to said inlet of said venturi; and
a third conduit portion extending away from said second inlet and extending to said first conduit portion at a position along said first conduit portion spaced from said outlet.

12. The vehicle washing apparatus of claim 11 further comprising:
a first electronic control valve positioned along said first conduit portion; and
a controller disposed in electronic communication with said first electronic control valve and configured to selectively open and close said first electronic control valve.

13. The vehicle washing apparatus of claim 12 further comprising:
a second electronic control valve positioned along said second conduit portion, said controller disposed in electronic communication with said second electronic control valve and configured to selectively open and close said second electronic control valve.

14. The vehicle washing apparatus of claim 1 wherein said first vertical section and said second vertical section extend in a first plane and said horizontal section extends parallel to and spaced from said first plane.

15. The vehicle washing apparatus of claim 14 wherein said distribution conduit further comprises:
at least one arcuate corner portion extending between one of said first and second vertical sections and said horizontal section, wherein said at least one arcuate corner portion is arcuate in a second plane transverse to said first plane.

16. A vehicle washing apparatus comprising:
a fluid mixing circuit having a first inlet configured to receive a washing liquid, a second inlet spaced from the first inlet and configured to receive a detergent liquid, and an outlet for emitting mixed washing liquid and detergent liquid, said outlet in fluid communication with both of said first inlet and said second inlet;
a distribution conduit extending in a u-shape with a first vertical section, a second vertical section, and a horizontal section extending transverse to and between said first vertical section and said second vertical section, said distribution conduit having an interior passageway defining a flow path for the mixed washing liquid and detergent liquid and a third inlet in fluid communication with said outlet to receive the mixed washing liquid and detergent liquid;
a first plurality of spray nozzles each mounted on one of said first vertical section and said second vertical section of said distribution conduit and in fluid communication with said interior passageway;
a second plurality of spray nozzles each mounted on said horizontal section of said distribution conduit and in fluid communication with said interior passageway; and
wherein at least each of said first plurality of spray nozzles is a fluidic oscillator.

17. The vehicle washing apparatus of claim 16 wherein each of said second plurality of spray nozzles includes an outlet side and a self-sealing valve positioned at said outlet side.

18. The vehicle washing apparatus of claim 16 wherein said distribution conduit further comprises:
at least one arcuate corner portion extending between one of said first and second vertical sections and said horizontal section, wherein said outlet of said fluid mixing circuit communicates with said interior passageway at said at least one arcuate corner portion.

19. The vehicle washing apparatus of claim 16 wherein at least some of said first plurality of spray nozzles are positionable in a plurality of different static positions.

20. The vehicle washing apparatus of claim 19 wherein at least some of said second plurality of spray nozzles are positionable in respective fixed static positions.
